(19) United States
(12) Patent Application Publication
(10) Pub. No.: US 2002/0023879 A1
(43) Pub. Date: Feb. 28, 2002

(54) Method and system for hemodialysis for use in a non-clinical environment

(76) Inventor: Richard I. Hadden, Oxford, MS (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/796,096

(22) Filed: Feb. 28, 2001

Related U.S. Application Data
(60) Provisional application No. 60/185,284, filed on Feb. 28, 2000.

(51) Int. Cl. B01D 61/24; B01D 61/28; B01D 61/32

(52) U.S. Cl. 210/646; 210/645; 210/321.71

(57) ABSTRACT

A hemodialysis system that is particularly suited for use in a non-clinical environment. The hemodialysis system includes a dialyzer, a pressurizable dialysate supply mechanism, a dialysate collection mechanism, an arterial line, a venous line, a first flow resistance, a second flow resistance, a third flow resistance and a control system. The dialyzer has a blood flow path and a dialysate flow path that are in communication through a membrane. The blood flow path has a blood entry port and a blood exit port. The dialysate flow path has a dialysate entry port and a dialysate exit port. The pressurizable dialysate supply mechanism is operably connected to the dialysate entry port. The dialysate collection mechanism is operably connected to the dialysate exit port. The arterial line is operably connected to the blood entry port. The venous line is operably connected to the blood exit port. The first flow resistance is operably connected between the dialysate supply mechanism and the dialyzer. The second flow resistance is operably connected between the dialyzer and the dialysate collection mechanism. The third flow resistance is operably connected to the venous line. The control system adjusts pressure in the dialysate supply mechanism, the first flow resistance, the second flow resistance and the third flow resistance.

### CROSS-REFERENCE TO RELATED APPLICATION

This application claims priority under 35 U.S.C. §119(e) to, and hereby incorporates by reference, U.S. Provisional Application No. 60/185,284, filed Feb. 28, 2000.

### BACKGROUND OF THE INVENTION

The present invention relates to a method and system for hemodialysis. More particularly, the present invention relates to a method and system for hemodialysis that is particularly suited for use in a non-clinical environment.

While administering hemodialysis on a daily basis provides the best control of the patient's condition, the length of the dialysis session and the distance from a patient's residence to the hemodialysis clinic makes daily hemodialysis unfeasible. As such, hemodialysis sessions traditionally take place three times per week. Each hemodialysis session typically lasts about four hours.

While performing hemodialysis at this interval reduces patient inconvenience, it increases the likelihood that the patient will become hypercatabolic between sessions. When this occurs, the patient must undergo additional treatment that is longer and more physically draining than a regular hemodialysis session.

Chronic hemodialysis traditionally requires significant quantities of dialysate. Volumes of the order of 120 liters of dialysate for each dialysis session are necessary to permit sufficient exchanges by diffusion at the level of the membrane of the dialyzer and so to purify the blood of a patient who is experiencing partial or total kidney failure.

Conventional hemodialysis techniques require complex machines and procedures that consist notably of facilities for water treatment to prepare water of a sufficient quality with respect to mineral and bacteriological requirements. The purified water is added to a concentrate to make the dialysate fluid required. In spite of the complex, costly and time consuming procedures used to prepare the purified water, significant risks of contamination remain.

Machines for performing hemodialysis in a hospital or clinical environment are very cumbersome and very difficult to use by an unqualified person. It is due to this fact that notably it is generally unthinkable to let a patient connect to the dialysis machine without medical assistance and/or surveillance. The complexity of present dialysis machinery requires the proximity of technicians capable of assuring their maintenance.

### SUMMARY OF THE INVENTION

The present invention is a hemodialysis system that is particularly suited for use in a non-clinical environment. The hemodialysis system includes a dialyzer, a pressurizable dialysate supply mechanism, a dialysate collection mechanism, an arterial line, a venous line, a first flow resistance, a second flow resistance, a third flow resistance and a control system.

The dialyzer has a blood flow path and a dialysate flow path that are in communication through a membrane. The blood flow path has a blood entry port and a blood exit port. The dialysate flow path has a dialysate entry port and a dialysate exit port.

The pressurizable dialysate supply mechanism is operably connected to the dialysate entry port. The dialysate collection mechanism is operably connected to the dialysate exit port. The arterial line is operably connected to the blood entry port. The venous line is operably connected to the blood exit port.

The first flow resistance is operably connected between the dialysate supply mechanism and the dialyzer. The second flow resistance is operably connected between the dialyzer and the dialysate collection mechanism. The third flow resistance is operably connected to the venous line. The control system adjusts pressure in the dialysate supply mechanism, the first flow resistance, the second flow resistance and the third flow resistance to produce desired dialysate and ultrafiltrate flow rates.

### BRIEF DESCRIPTION OF THE DRAWINGS

FIG. 1 is a perspective view of a dialysis system of the present invention.

FIG. 2 is a schematic illustration of the dialysis system.

FIG. 3 is a sectional view of the dialysis system.

FIG. 4 is another sectional view of the dialysis system.

FIG. 5 is an enlarged view of the dialysate supply mechanism illustrated in FIG. 2.

FIG. 6 is a perspective view of an alternative configuration of the dialysis system.

FIG. 7 is an enlarged view of the dialysate supply mechanism illustrated in FIG. 7.

FIG. 8 is an alternative embodiment of the dialysis system.

FIG. 9 is a schematic illustration of the dialysis system.

FIG. 10 is a graph of a study using the method of the present invention.

FIG. 12 is a graph of another study using the method of the present invention.

FIG. 12 is a graph of yet another study using the method of the present invention.

FIG. 13 is a graph of still another study using the method of the present invention.

FIG. 14 is a graph comparing the performance of the method of the present invention.

### DETAILED DESCRIPTION OF PREFERRED EMBODIMENTS

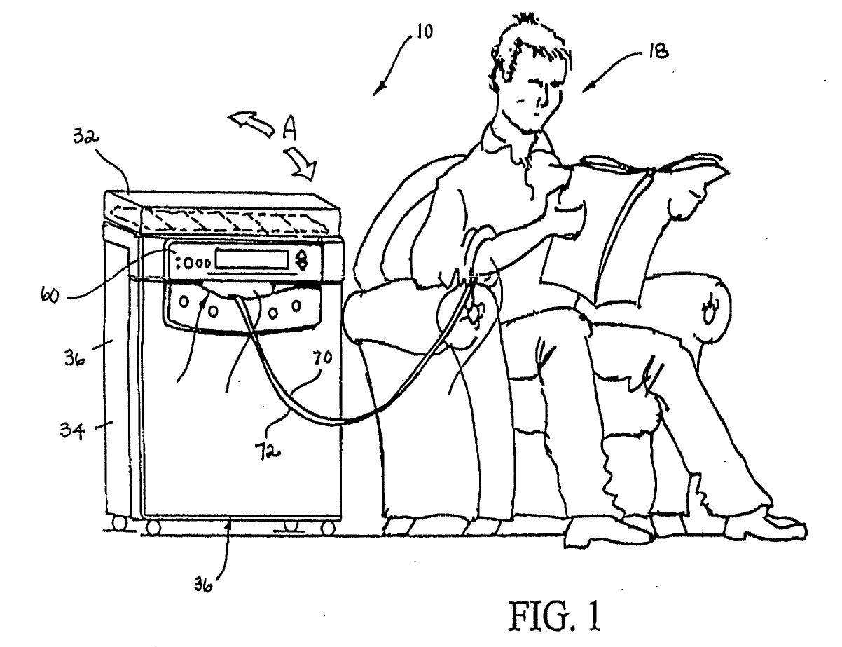

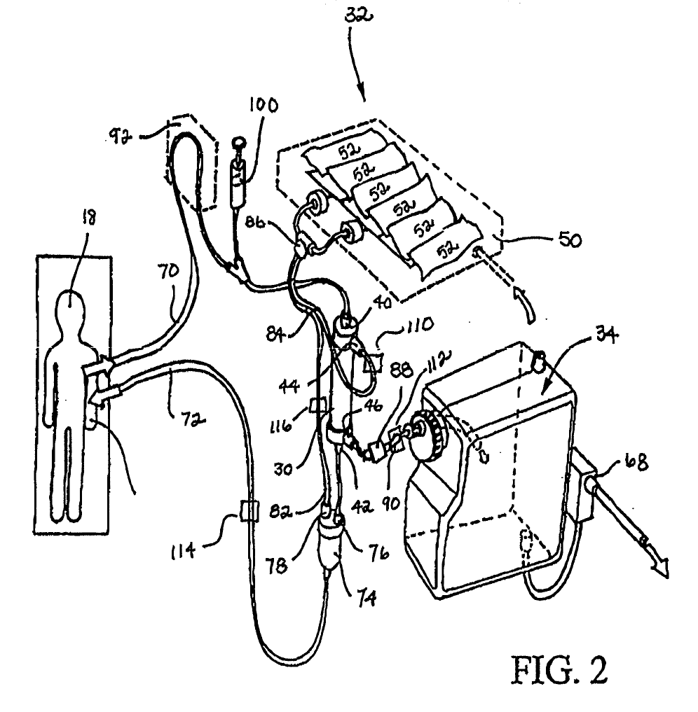

An embodiment of the present invention relates to a dialysis system and a method of using the dialysis system that is particularly suited for use in a non-clinical environment. The dialysis system 10 generally includes a dialyzer 30, a dialysate supply mechanism 32 and a dialysate collection mechanism 34, as most clearly illustrated in FIGS. 1 and 2.

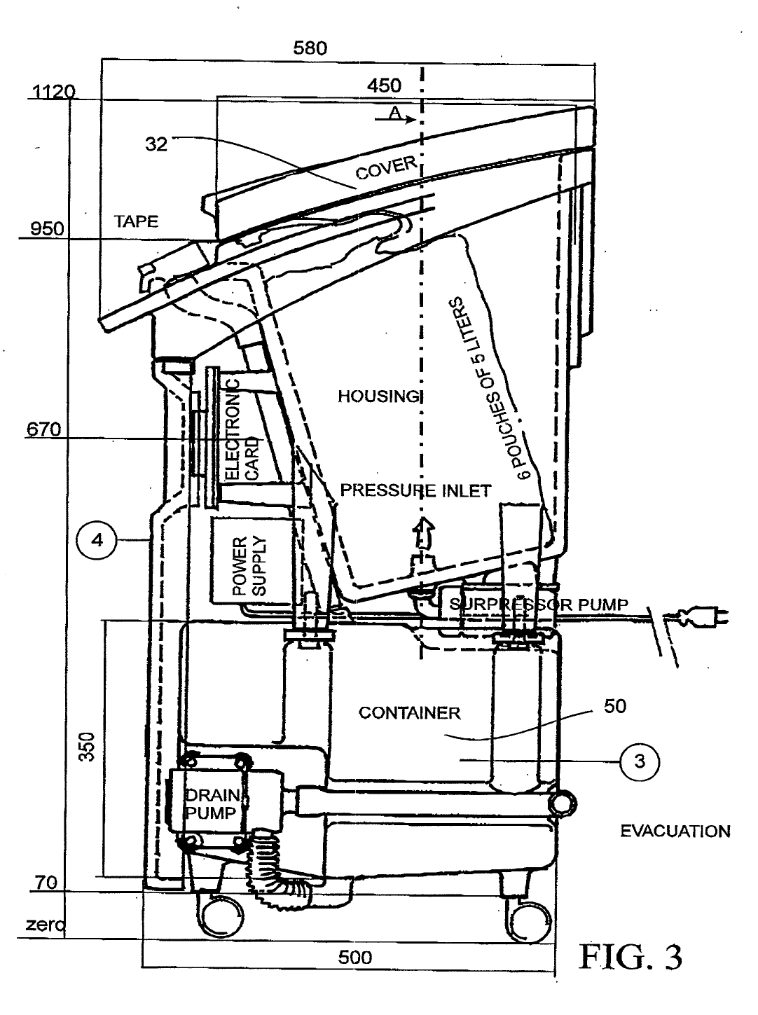

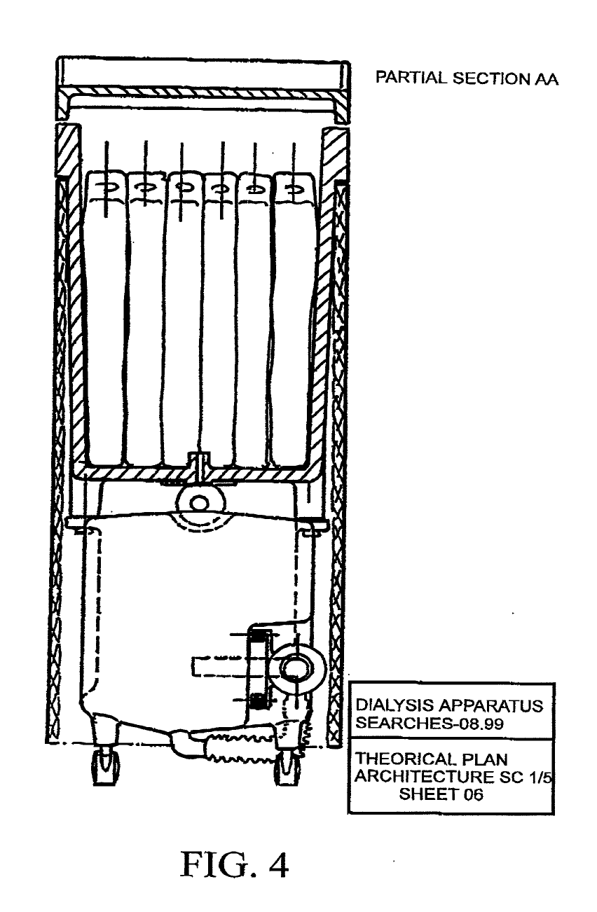

To facilitate use of the dialysis system 10 in a non-clinical environment, the components of the dialysis system 10 are preferably all contained within an enclosure 36, as most clearly illustrated in FIGS. 1, 3 and 4.

The dialysis system 10 of the present invention, through its simplicity of use and controls, allows a patient 18 to perform dialysis treatments in a non-clinical environment such as in the patient's home without the need for skilled medical assistance. As such, the present invention is particularly suited for use by patients who are experiencing significant kidney failure such that the patients must be dialyzed regularly, preferably almost daily.

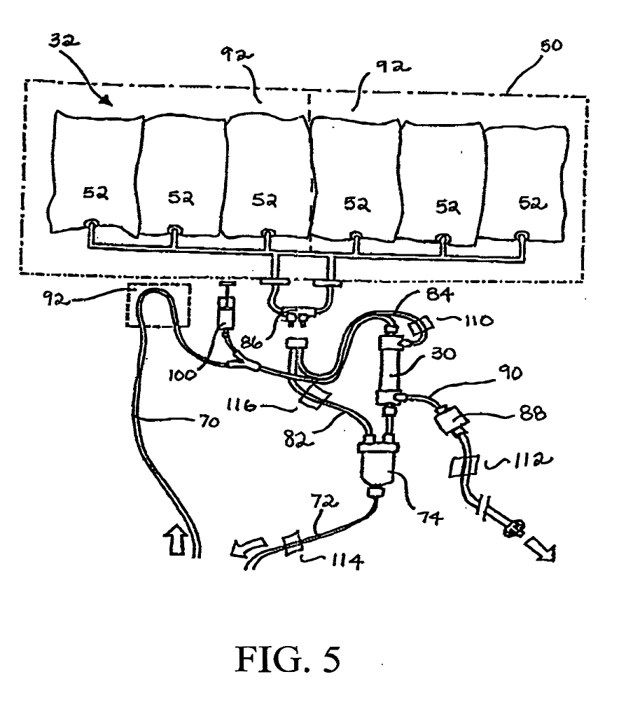

The dialyzer 30 preferably has a hollow fiber membrane configuration. The dialyzer 30 has a blood flow path with a blood entry port 40 and a blood exit port 42, as most clearly illustrated in FIGS. 2 and 5. The dialyzer 30 also has a dialysate flow path with a dialysate entry port 44 and a dialysate exit port 46. The blood flow path and the dialysate flow path are in communication through the hollow fiber membranes.

The dialysate supply mechanism 32 is operably connected to the dialysate entry port 44 and includes a pressurizable container 50 that is adapted to receive at least one dialysate pouch 52. The dialysate container 50 preferably has a housing and a lid that form a strong seal with respect to each other to prevent pressurized gases placed in the dialysate container 50 from escaping therefrom.

The dialysate container 50 may be pressurized with a gas such as air, nitrogen or any other gas that poses a minimal contamination risk with the dialysate. Gas pressure in the dialysate container 50 is preferably controlled by a pressure regulating valve or other suitable device. The pressure control may be accomplished automatically or manually. A person of ordinary skill in the art will appreciate that it is also possible to impart pressure in the dialysate container 50 using mechanical means.

The dialysate used with the dialysate supply mechanism 32 is preferably sterile, premixed dialysate. However, a person of ordinary skill in the art will appreciate that the dialysate system 10 may be adapted for use with other forms of dialysate such as dialysate concentrate. The dialysate is preferably provided in the dialysate supply mechanism 32 in the form of at least one flexible pouch 52 that contains the sterile, premixed dialysate. In addition to supplying dialysate, the dialysate supply mechanism 32 may also supply a substitution liquid, which is described in more detail below.

This embodiment is particularly suited for chronic dialysis where the volume of dialysate needed and the length of the dialysis session are known. Since this volume is relatively reduced of the order of 25 to 40 liters, the container 50 can be configured in such a way that it can contain all the necessary volume for a chronic dialysis treatment.

The dialysate collection mechanism 34 is operably connected to the dialysate exit port 46 and collects spent dialysate and the ultrafiltrate that is collected from the patient, as most clearly illustrated in FIG. 2. Depending on the amount of dialysate used in a dialysate session, the dialysate collection mechanism 34 may collect all of the spent dialysate the ultrafiltrate for later disposal. Alternatively, the dialysate collection mechanism 34 is operably connected to a drain for disposing of the spent dialysate and ultrafiltrate. In certain locations it may also be necessary to use a pump 68 to convey the spent dialysate and ultrafiltrate into the drain.

The dialysis system 10 of the present invention also includes an arterial line 70 and a venous line 72. The arterial line 70 connects the blood entry port 40 to an arteriovenous fistula (not represented in detail) implanted in a forearm of the patient 18. The venous line 72 extends between the arteriovenous fistula and a venous chamber 74.

The venous chamber 74 includes a first entry port 76 and a second entry port 78. The first entry port 76 is connected to the blood exit port 42. The second entry port 78 is connected to a substitution liquid supply mechanism through line 82. The substitution liquid is preferably dialysate that is provided by the dialysate supply mechanism 32.

A dialysate supply line 84 is connected between a separator 86 that is joined to the dialysate supply mechanism 32. The substitution liquid supply line 82 extends between the separator 86 and the venous chamber 74. A spent dialysate recovery line 90 is connected to the dialysate exit port 46 to the dialysate collection mechanism 34.

The dialysis system 10 also preferably includes a pump 92 controls the rate at which the blood is moved through the dialyzer 30. The pump 92 is preferably a peristaltic pump. However, a person of ordinary skill in the art will appreciate that alternative pump configurations may also be used.

The dialysis system 10 also preferably includes a flow meter 88 on the spent dialysate recovery line 90 to measure the rate at which dialysate and ultrafiltrate flows from the dialyzer 30. The dialysis system 10 further preferably includes a push syringe 100 or equivalent automatically controlled device for introducing an anticoagulant into the arterial line 70.

The dialysis system 10 preferably has a control panel 60 with control buttons that permit easy use of the dialysis system 10 by the patient alone or with an assistant who is not necessarily qualified in the operation of dialysis machines, as most clearly illustrated in FIG. 1. As an alternative to using buttons on the control panel 60, operation of the dialysis system 10 may be controlled by an infrared remote control. The dialysis system 10 may also have provisions for remote operation or monitoring from a distant central facility.

To limit the electronic control equipment used in conjunction with the dialysis system 10 of the present invention while preserving a reliable, simple and sure character of the machine, in one advantageous method of the invention, the lines 84 and 90 that link together the dialysate supply mechanism 32 and/or the substitution liquid to the dialyzer 30 and the venous chamber 74, respectively, in one implementation of the invention may have resistances determined and calibrated in a precise manner. The resulting flows are precisely known for a given range of pressure regulated inside the dialysate container 50 and a given range of resistance in the spent dialysate recovery line 90. Each of these items may be adjusted as needed during a dialysis session.

A first resistance generating device 110 is operably attached to the dialysate supply line 84. A second resistance generating device 112 is operably attached to the dialysate recovery line 90. A third resistance generating device 114 is operably attached to the venous line 72. A fourth resistance generating device 116 is operably attached to the substitution liquid supply line 82.

The resistance generating devices 110, 112, 114, 116 generate resistance by at least partially restricting the flow through the line to which the resistance generating device is attached. The resistance generating devices 110, 112, 114, 114 thereby enable the dialysate feed rate, the ultrafiltrate feed rate, and the substitution liquid feed rate to be adjusted. The resistance generating devices 110, 112, 114, 116 are controlled by hand or automatically and are preferably a valve, a narrowing, or an external clamping or any similar device having the requisite functions.

The resistances generated by the first, second, and fourth resistance generating devices 110, 112, 116 may be predetermined or adjustable according to the use of the machine. The resistance generated by the third resistance generating device 114 is variable corresponding to the blood pressure of the patient.

To maintain precise control of the dialysate and ultrafiltrate flows, the resistance produced by the first resistance generating device 110 is preferably predetermined, and the container pressure and the resistance produced by the second resistance generating device 112 is adjustable. It is also possible to predetermine the pressure of the dialysate container 50, and to adjust the resistances produced by the first and second resistance generating devices 110, 112.

Preferably, the resistance provided by the first resistance generating device 110 is calibrated so that, for a given pressure in the dialysate container 50, the flow of dialysate from the dialysate container 50 is between 80 and 500 milliliters per minute and preferably between 150 and 300 milliliters per minute.

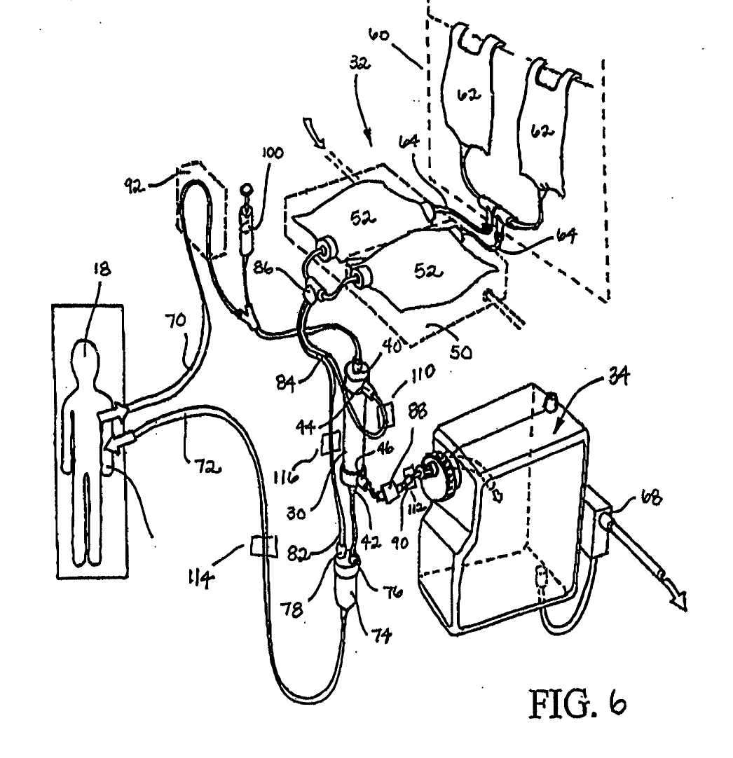

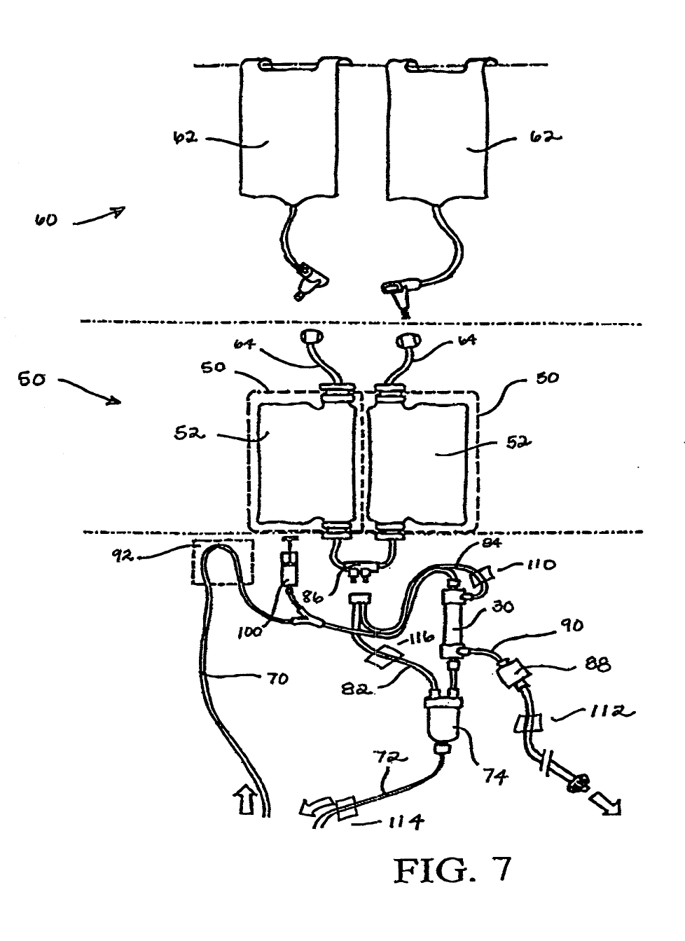

In an alternative embodiment of the present invention that is particularly suited for use with acute dialysis, the dialysis supply mechanism 32 has at least two compartments 92 formed therein, as most clearly illustrated in FIGS. 6 and 7. Each of the compartments is adapted to receive at least one of the dialysate pouches 52. The compartments 92 are individually pressurizable so that pouches in each compartment 92 may be replaced separately. This embodiment thereby enables the treatment to be done in a continuous and uninterrupted manner.

In another alternative embodiment of the present invention that is particularly suited for use with acute dialysis, the dialysate supply mechanism 32 includes a supplemental dialysate supply device 60, as most clearly illustrated in FIGS. 6 and 7. The supplemental dialysate supply device 60 preferably includes at least one dialysate pouch 62. The dialysate pouches 62 are operably connected to the dialysate pouches 52 in the dialysate container 50 through lines 64 such that at selected times, the dialysate in the dialysate pouches 52 may be replenished from the dialysate pouches 62.

To facilitate manipulations and to avoid the opening of the container 50 under pressure of gas, pouches 52 are left in place in the container, and the refilling occurs by means of pouches 62 that are replaced regularly. The presence of two pouches in the container 50 allows an alternate filling by gravity from the reserve pouches. This technique is accomplished through the alternative pinching of lines to fill successively and alternately the pouches 52 in the container 50 from the reserve pouches 62 containing the reserve premixed dialysate.

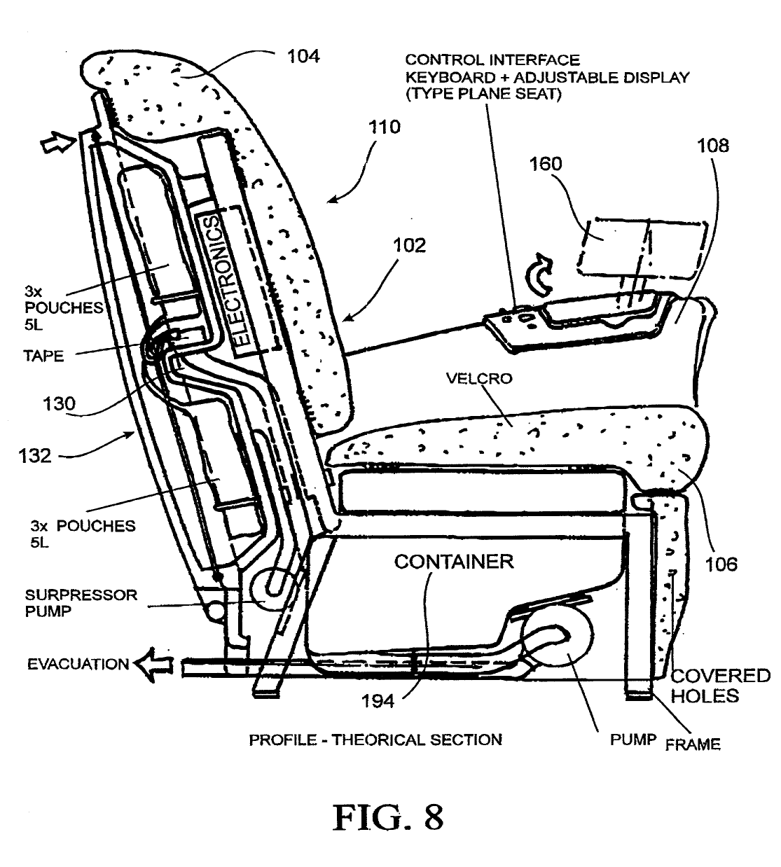

In yet another embodiment of the present invention, the components of the dialysis system 110 are integrated into a chair 102, as most clearly illustrated in FIG. 8. In particular, the dialyzer 130 and the dialysis supply mechanism 132 are integrated into a back portion 104 of the chair 102. The dialysate collection mechanism 134 is integrated in a seat portion 106 of the chair 102. The control panel 160 is integrated into an arm portion 108 of the chair 102.

This embodiment of the present invention enables a person who is undergoing the dialysis session to sit in a comfortable position on the chair 102. When it is not desired to use the dialysis system 110, the control panel 160 folds at least partially into the arm portion 108 so that the chair 102 may be used as a conventional piece of furniture in the patient's home.

In operation, a first weight of dialysate to be used is measured prior to use, and a second weight of the dialysate plus ultrafiltrate is measured continuously during the dialysis session. This procedure allows continuous calculation of the ultrafiltrate volume removed from the patient throughout a treatment session by subtraction of the first weight from the second weight or at any time by subtraction of the weight of dialysate used from weight the dialysate plus ultrafiltrate evacuated from the exit of the dialyzer. The weight of the dialysate used is the initial weight of the sterile dialysate minus the current weight of the sterile dialysate remaining in the container.

The hemodialysis method of the present invention permits the determination of the quantity of ultrafiltrate that has been evacuated from a patient during the dialysis by a simple arithmetic calculation. The sterile, premixed dialysate “D” under pressure is contained initially, meaning before the dialysis, in a container as described above and one proceeds continuously, during all the length of the dialysis to take a first weight to determine the weight of it or the change in its weight.

The dialysate along with ultrafiltrate “D+UF” is evacuated continuously during dialysis into a receiving tank and one proceeds continuously, during the length of the dialysis, to take a second weight to determine the weight of the evacuated dialysate plus ultrafiltrate. Throughout the dialysis session, a control system 120 permits automatic and continuous calculation of the difference “UF”=“D+UF”−“D” which is to say, the value for the ultrafiltrate.

For the duration of the chronic dialysis session, which would be about two and half hours, the dialysate supply line 84 can deliver about 25 liters of dialysate to the dialyzer 30, and the substitution liquid supply line 82 can deliver about 5 liters of substitution liquid into the venous line of the patient.

It is possible to conduct the dialysis using 30 liters of dialysate in the absence of any substitution liquid. It is also possible to do dialysis using any volume of dialysate between these two values between 25 and 30 liters and to adjust the volume of substitution liquid as a consequence between five and zero liters. Furthermore, in situations requiring additional dialysis, it is possible to modify the system to accommodate large dialysate volumes.

The hemodiafiltration method permits improvement in the performance of blood purification by allowing an increased fluid convection flow in the dialyzer to take place in addition to diffusion across the membrane of the dialyzer 30. In the case of hemodiafiltration, the volume of substitution liquid injected into the venous line is withdrawn to the dialysate side of dialyzer during the course of a treatment. The machine withdraws through the membrane of the dialyzer 30 a certain quantity of ultrafiltrate fluid from the blood, for example one to two liters per day, that the patient cannot eliminate.

The resistances produced by the first, second and fourth resistance generating devices 110, 112, 116, and the container pressure are controlled by hand or automatically to generate a combination of resistances, or change of pressures and thus change of flows, ensuring that in addition to the ultrafiltrate the exact amount of substitution liquid injected into the patient is removed from the patient before the end of a treatment session.

In the case of excessive amounts of ultrafiltrate to be drawn alternatively a volumetric device 88, preferentially an ultrafiltration pump, can be used to create a depression. In this case it is preferable that the dialysate supply line 84, that is connected between the pouches in the dialysate container 50 and the dialyzer 30 has a resistance that is sufficiently large that the depression created draws fluid more easily through the dialyzer membrane than from the dialysate pouches, so that the dialysate flows from the pouches 52 toward the dialyzer 30 remains substantially unchanged. The pressure in the container 50 must be sufficient so that the flow of the dialysate is between 80 and 500 milliliters per minute and preferably between 150 and 300 milliliters per minute in the dialysate feed line 84.

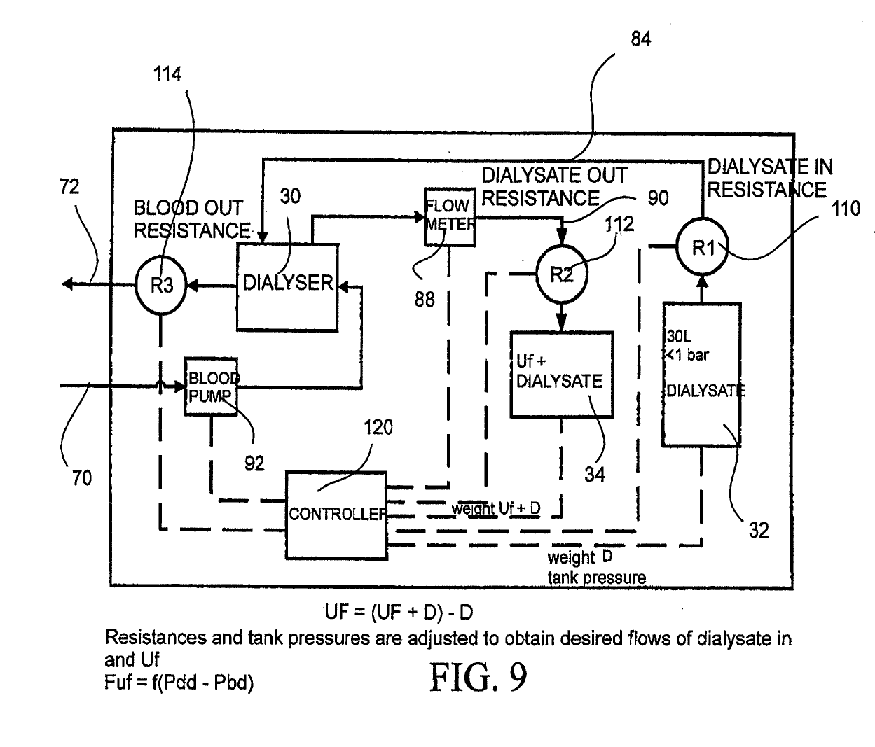

Most of these components are arranged in the enclosure 36. For acute dialysis, the lid of the pressurized container remains closed while an outer cover of the machine is raised during use and standby pouches 62 are suspended vertically. The electronic controls are also arranged inside this housing. These are coupled to the control panel as illustrated in FIG. 9.

In a variant of the method according to the invention, it is also possible to place within the dialysate container 50 a bag of medicinal substance as for example an anticoagulant connected by an appropriated line (no represented) to the arterial line 16 or to the venous chamber 74, this line comprising an adjustable fifth resistance generating device to cause the desired flow. The same pressure applied to the medicinal substance fluid bag in the container and the restraint of the fifth resistance generating device allow the dialysis system to determine the flow of the medicinal substance and to regulate its flow precisely.

The methods and the machine according to the invention can adjust to various uses as for example acute dialysis or chronic dialysis already mentioned but also automatic peritoneal dialysis.

The product and method of the present invention are described in the following example. This example is provided as an illustration of the invention and is not intended to limit the invention.

Exhibit 1

A study was conducted to evaluate the performance of the method of the present invention using the system illustrated in FIG. 2. The experiment was performed on a generally healthy pig weighing about 30 kilograms. An F-80 dialyzer was used in this experiment. The experiment was conducted for approximately eight minutes with data readings taken every 30 seconds. The dialysate in flow rate during the experiment was approximately 190 milliliters per minute.

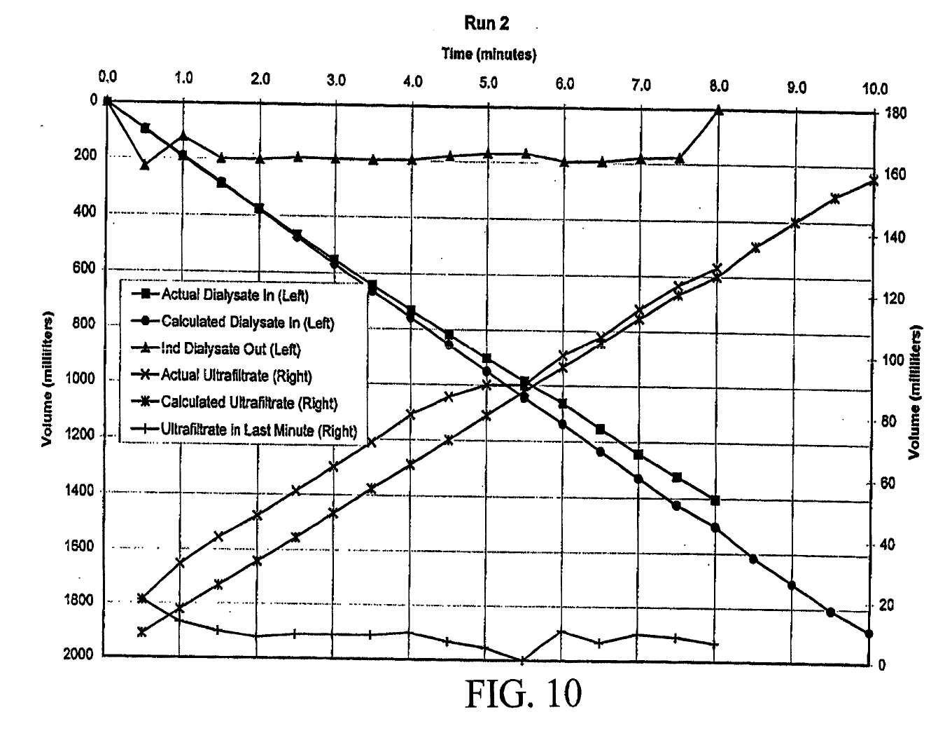

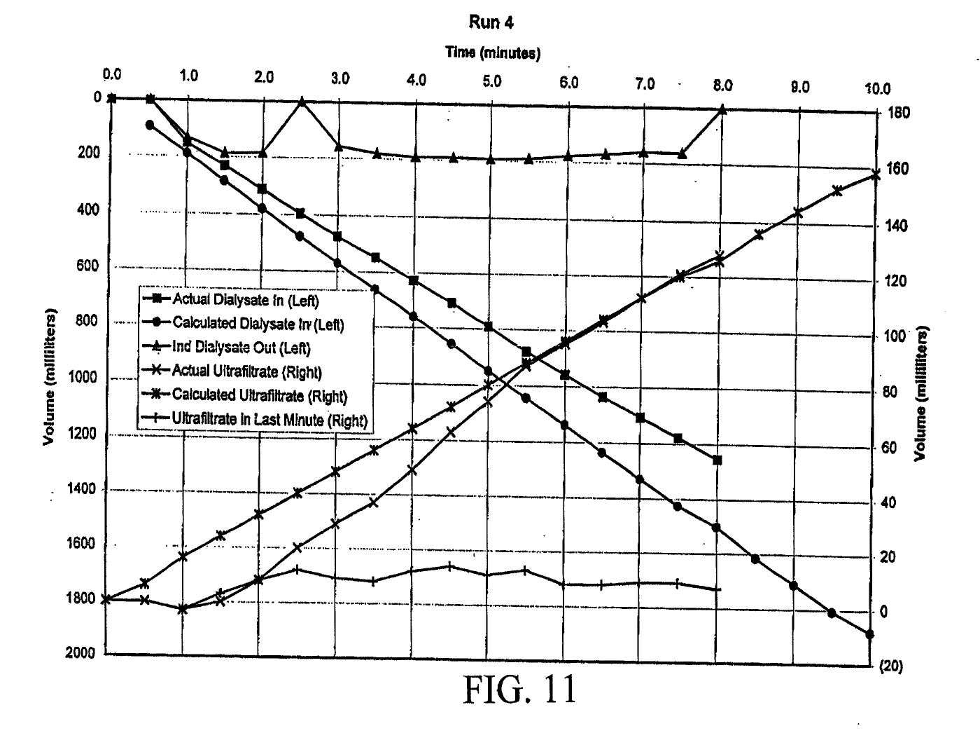

The results of this examination, which are reported in FIG. 10, indicate that the ultrafiltrate rate can be smoothly brought down. The results also indicate that the actual dialysate in volume correlated with the calculated dialysate in. The results further indicate that the actual ultrafiltrate correlated with the calculated with the calculated ultrafiltrate.

Exhibit 2

The method set forth in Exhibit 1 was repeated to evaluate the ability to smoothly bring up the ultrafiltrate using the method of the present invention. The results of this examination are reported in FIG. 11.

The results indicate that the ultrafiltrate rate can be smoothly brought up. The results also indicate that the actual dialysate in volume correlated with the calculated dialysate in. The results further indicate that the actual ultrafiltrate correlated with the calculated with the calculated ultrafiltrate.

Exhibit 3

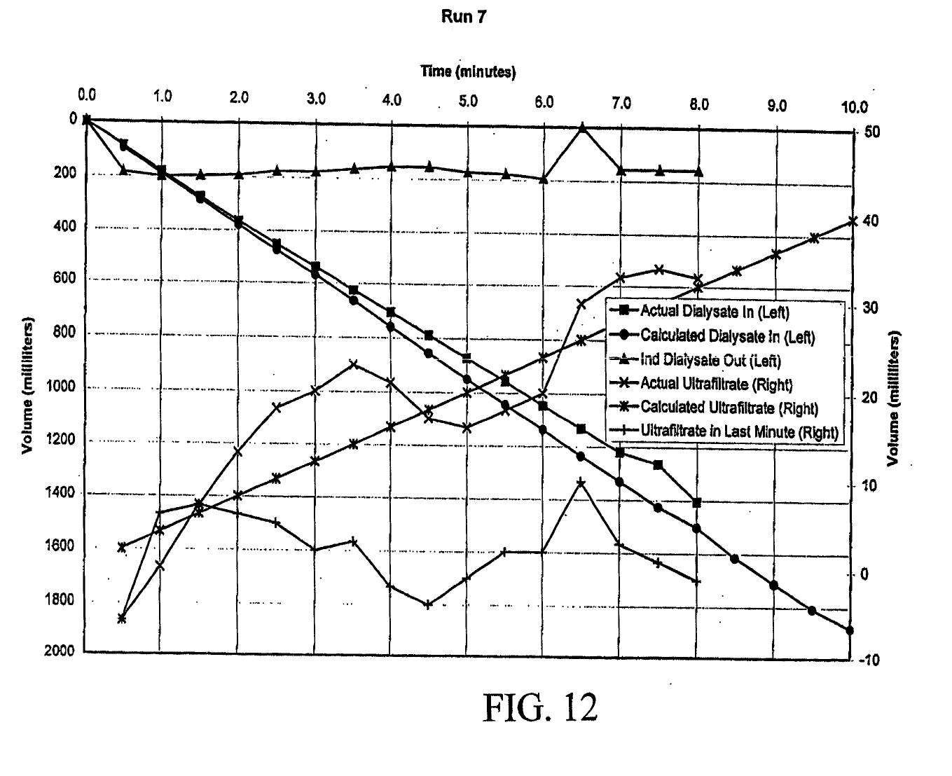

The method set forth in Exhibit 1 was repeated to evaluate the ability to produce a stable oscillatory profile for the ultrafiltrate using the method of the present invention. The results of this study are reported in FIG. 12

The results indicate that the ultrafiltrate rate can be adjusted to produce an oscillatory profile. The results also indicate that the actual dialysate in volume correlated with the calculated dialysate in.

Exhibit 4

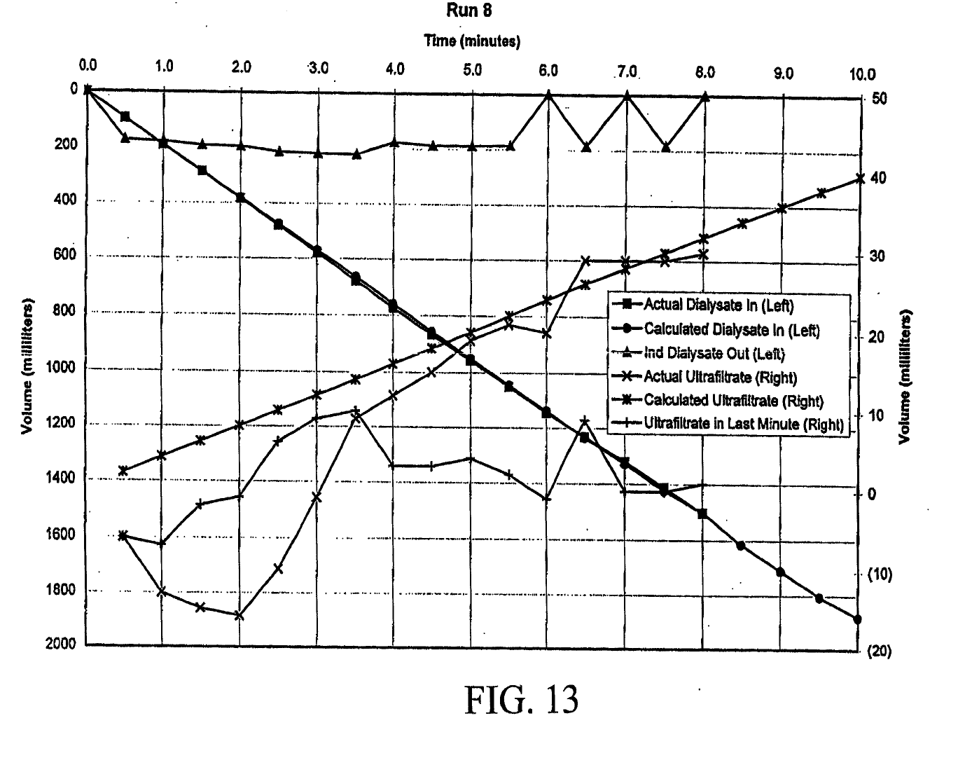

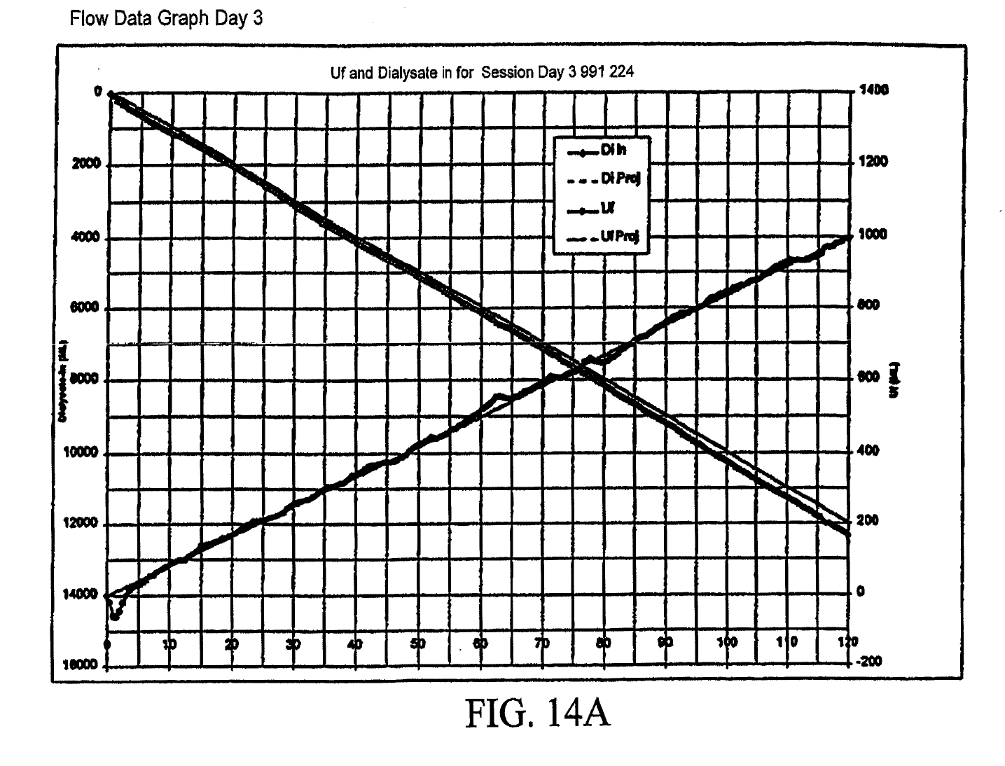

The method set forth in Exhibit 1 was repeated to evaluate the ability to produce large negative ultrafiltrate flows using the method of the present invention. The results of this study are reported in FIG. 13.

The results indicate that the ultrafiltrate rate can be smoothly brought up. The results also indicate that the actual dialysate in volume correlated with the calculated dialysate in. The results further indicate that the actual ultrafiltrate correlated with the calculated with the calculated ultrafiltrate.

Exhibit 5

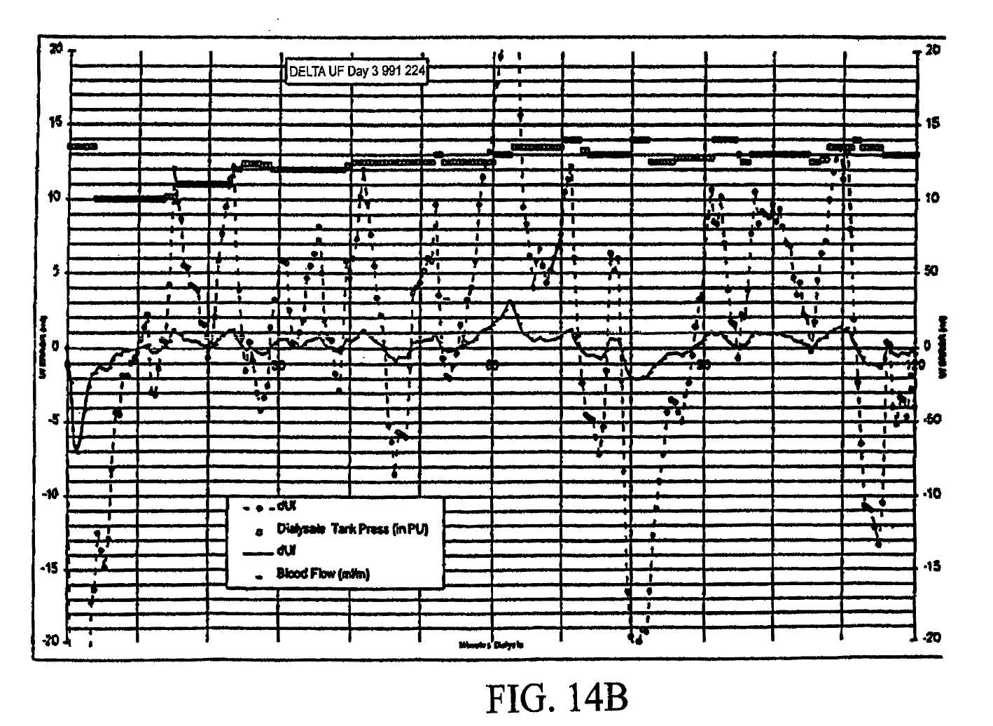

The method set forth in Exhibit 1 was repeated to evaluate the relationship between the ultrafiltrate flow rate and the pressure in the dialysate supply mechanism. The length of this study was 120 minutes. The results of this study are reported in FIG. 14, which includes one graph that compares the actual and projected values for dialysate in and ultrafiltrate. The second graph set forth the change in ultrafiltrate, dialysate tank pressure and blood flow.

The results indicate that the actual and projected values for the dialysate in and the ultrafiltrate closely correlate with each other. The results also indicate this correlation can be produced by modifying the pressure in the dialysate supply mechanism.

It is contemplated that features disclosed in this application, as well as those described in the above applications incorporated by reference, can be mixed and matched to suit particular circumstances. Various other modifications and changes will be apparent to those of ordinary skill.

1. A hemodialysis system that is particularly suited for use in a non-clinical environment, the hemodialysis system comprising:
a dialyzer having a blood flow path and a dialysate flow path that are in communication through a membrane, wherein the blood flow path has a blood entry port and a blood exit port, and wherein the dialysate flow path has a dialysate entry port and a dialysate exit port;
a pressurizable dialysate supply mechanism operably connected to the dialysate entry port;
a dialysate collection mechanism operably connected to the dialysate exit port;
an arterial line operably connected to the blood entry port;
a venous line operably connected to the blood exit port;
a first resistance mechanism operably connected between the dialysate supply mechanism and the dialyzer;
a second resistance mechanism operably connected between the dialyzer and the dialysate collection mechanism;
a third resistance mechanism operably connected to the venous line; and
a control system that adjusts pressure in the dialysate supply mechanism, the first resistance mechanism, the second resistance mechanism and the third resistance mechanism.

2. A method of performing hemodialysis that is particularly suited for use in a non-clinical environment, the method comprising:
providing a dialyzer having a blood flow path and a dialysate flow path that are in communication through a membrane, wherein the blood flow path has a blood entry port and a blood exit port, and wherein the dialysate flow path has a dialysate entry port and a dialysate exit port;
feeding dialysate from a pressurizable dialysate supply mechanism to the dialysate entry port;
feeding blood through an arterial line, the blood flow path and a venous line, wherein the arterial line is operably connected to the blood entry port, and wherein the venous line is operably connect to the blood exit port;
transferring ultrafiltrate from the blood through the membrane;
feeding dialysate and ultrafiltrate from the dialysate flow path to a dialysate collection mechanism;
imparting a first flow resistance between the dialysate supply mechanism and the dialyzer;
imparting a second flow resistance between the dialyzer and the dialysate collection mechanism;
imparting a third flow resistance in the venous line; and
adjusting pressure in the dialysate supply mechanism based upon one or more of the first flow resistance, the second flow resistance and the third flow resistance.

3. The method of claim 2, wherein the first flow resistance, the second flow resistance, and the third flow resistance are predetermined.

4. The method of claim 2, wherein the first flow resistance, the second flow resistance, and the third flow resistance are adjustable.

5. The method of claim 2, wherein the dialysate supply mechanism is pressurized with a gas.

6. The method of claim 2, and further comprising:
measuring a flow rate of dialysate flowing out of the dialysate supply mechanism; and
measuring a flow rate of dialysate and ultrafiltrate flowing into the dialysate collection mechanism.

7. The method of claim 2, wherein the dialysate supply mechanism is maintained at an interior pressure to provoke out-flow of a substitution fluid into the venous line.

8. The method of claim 7, wherein sterile, premixed dialysate is used for the substitution fluid.

9. The method of claim 7, wherein adjusting the pressure of the dialysate supply mechanism, the first flow resistance and the second flow resistance controls the dialysate and ultrafiltrate flow rates.

10. The method of claim 2, wherein the first flow resistance is predetermined, and wherein the pressure in the dialysate supply mechanism and the second flow resistance are variable to control the dialysate and ultrafiltrate flow rates.

11. The method of claim 1, wherein the pressure of the dialysate supply mechanism is predetermined, and wherein the first flow resistance and the second flow resistance are variable to control the dialysate and ultrafiltrate flow rates.

12. The method of claim 9, wherein the first flow resistance is calibrated so that, for a given pressure in the dialysate supply mechanism, the dialysate flow rate is between 150 and 300 milliliters per minute.

13. The method of claim 11, and further comprising controlling the dialysate and ultrafiltrate flow rate with an ultrafiltration pump.

14. The method of claim 1, wherein the first flow resistance, the second flow resistance and the third flow resistance are generated by a narrowing or flow restricting device.

15. The method of claim 1, and further comprising feeding dialysate to the dialysate supply mechanism from at least one pouch that is operably connected to the dialysate supply mechanism.

16. A hemodialysis system that is particularly adapted for use in a non-clinical environment, the hemodialysis system comprising:
a dialyzer having a blood circuit with a blood entry port and a blood exit port, and having a dialysate circuit with a dialysate entry port and a dialysate exit port;
a means of providing dialysate;
a dialysate collection mechanism;
an arterial line connected between an arteriovenous fistula and the first entry of the dialyzer;
a dialysate supply line connected between the means of providing dialysate and the dialysis entry port, wherein the dialysate supply line has a first resistance to flow;
a dialysate collection line connected between the dialysate collection mechanism and the dialysis exit port, wherein the dialysate collection line has a second resistance to flow;
a first venous line connected between the blood exit port and a venous chamber;
a second venous line connected between an arteriovenous fistula and the venous chamber, wherein the second venous line has a third resistance to flow; and
a substitution liquid supply line connected between a substitution liquid supply and the venous chamber, wherein the substitution liquid supply line has a fourth resistance to flow.

17. The hemodialysis system according to the claim 22, wherein the first flow resistance, the second flow resistance and the third flow resistance are each predetermined.

18. The hemodialysis system according to the claim 22, wherein the first flow resistance, the second flow resistance and the third flow resistance are each adjustable.

19. The hemodialysis system according to the claim 22, wherein the substitution fluid is a sterile, premixed dialysate.

20. A method of hemodialysis that is particularly suited for use in a non-clinical environment by means of a machine comprising:
providing a dialyzer having blood circuit with a blood entry port and a blood exit port, and having a dialysate circuit with a dialysate entry port and a dialysate exit port;
applying pressure to a dialysate supply mechanism to feed dialysate to the dialysate entry port;
imparting a first flow resistance between the dialysate supply mechanism and the dialysate entry port;
feeding dialysate from the dialysate exit port to a dialysate collection mechanism;
imparting a second flow resistance between the dialysate exit port and the dialysate collection mechanism;
feeding blood from an arteriovenous fistula to the blood entry port;
feeding blood from the blood exit port to the venous chamber;
feeding blood from the venous chamber to the arteriovenous fistula,
imparting a third flow resistance between the venous chamber and the arteriovenous fistula;
feeding a substitution liquid from a substitution liquid supply mechanism to a venous chamber;
imparting a fourth flow resistance between the substitution liquid supply mechanism and the venous chamber.

21. The method of claim 26, wherein the first flow resistance, the second flow resistance, and the third flow resistance are predetermined.

22. The method of claim 26, wherein the first flow resistance, the second flow resistance, and the third flow resistance are adjustable.

23. The method of claim 26, wherein pressure applied to the dialysate supply mechanism includes a gas under pressure.

24. The method of claim 26, wherein an ultrafiltrate resulting of the dialysis is continuously measured by weighing the dialysate coming to the dialysate entry port, weighing the mixture of dialysate and ultrafiltrate leaving the dialysate exit port, and calculating the difference between the weights.

25. The method of claim 29, and further comprising maintaining in the dialysate supply mechanism a sufficient interior pressure to provoke the out-flow of the dialysate in the dialysate supply line.

26. The method of claim 29, and further comprising maintaining in the substitution liquid supply mechanism a sufficient interior pressure to provoke the out-flow of the substitution liquid to the venous chamber.

27. The method of claim 28, wherein the first flow resistance is predetermined, and wherein the pressure in the dialysate supply mechanism and the second flow resistance are adjustable to control the dialysate and ultrafiltrate flow rates.

28. The method of claim 28, wherein the pressure in the dialysate supply mechanism is predetermined, and the first flow resistance and the second flow resistance are adjustable to control the dialysate and ultrafiltrate flow rates.

29. The method of claim 34, and further comprising calibrating the first flow resistance so that, for a given pressure in the container, the dialysate flow rate is between 150 and 300 milliliters per minute.

30. The method of claim 26, and further comprising connecting a volumetric device on the dialysate collection line.

31. The method of claim 38, wherein the volumetric device comprises an ultrafiltration pump.

32. The method of claim 26, wherein a flow restricting device generates first flow resistance, the second flow resistance, the third flow resistance and the fourth flow resistance.

33. The method of claim 26, wherein the dialysate supply mechanism includes at least one dialysate pouch, and wherein the pouches are connected alternately to the dialysate supply line.
